(19) United States
(12) Patent Application Publication
(10) Pub. No.: US 2019/0004694 A1
(43) Pub. Date: Jan. 3, 2019

(54) ELECTRONIC SYSTEMS AND METHODS FOR TEXT INPUT IN A VIRTUAL ENVIRONMENT

(71) Applicant: Guangdong Virtual Reality Technology Co., Ltd., Shenzhen City (CN)

(72) Inventors: ZHIXIONG LU, Shenzhen City (CN); JINGWEN DAI, Shenzhen City (CN); JIE HE, Shenzhen City (CN)

(21) Appl. No.: 15/657,182

(22) Filed: Jul. 23, 2017

(30) Foreign Application Priority Data
Jun. 30, 2017 (CN) PCT/CN2017/091262

(51) Int. Cl. G06F 3/0488; G06F 3/0354; G06F 3/03; G06F 3/0482

(52) U.S. Cl. CPC G06F 3/04883; G06F 3/0482; G06F 3/0304; G06F 3/03547

(57) ABSTRACT

The present disclosure includes an electronic system for text input in a virtual environment. The electronic system includes at least one hand-held controller, a detection system, and a text input processor. The at least one hand-held controller includes a touchpad to detect one or more gestures and electronic circuitry to generate electronic instructions corresponding to the gestures. The detection system determines a spatial position of the at least one hand-held controller and includes at least one image sensor to acquire one or more images of the at least one hand-held controller and a calculation device to determine the spatial position based on the acquired images. The text input processor performs operations that includes receiving the electronic instructions from the at least one hand-held controller and performing text input operations based on the received electronic instructions.

### FIELD OF THE INVENTION

The present disclosure relates to the field of virtual reality in general. More particularly, and without limitation, the disclosed embodiments relate to electronic devices, systems, and methods, for text input in a virtual environment.

### BACKGROUND OF THE INVENTION

Virtual reality (VR) systems or VR applications create a virtual environment and artificially immerse a user or simulate a user's presence in the virtual environment. The virtual environment is typically displayed to the user by an electronic device using a suitable virtual reality or augmented reality technology. For example, the electronic device may be a head-mounted display, such as a wearable headset, or a see-through head-mounted display. Alternatively, the electronic device may be a projector that projects the virtual environment onto the walls of a room or onto one or more screens to create an immersive experience. The electronic device may also be a personal computer.

VR applications are becoming increasingly interactive. In many situations, text data input at certain locations in the virtual environment are useful and desirable. However, traditional means of entering text data to an operational system, such as a physical keyboard or a mouse, are not applicable for text data input in the virtual environment. This is because a user immersed in the virtual reality environment typically does not see his or her hands, which may be at the same time holding a controller to interact with the objects in the virtual environment. Using a keyboard or mouse to input text data may require the user to leave the virtual environment or release the controller. Therefore, a need exists for methods and systems that allow for easy and intuitive text input in virtual environments without compromising the user's concurrent immersive experience.

### SUMMARY OF THE INVENTION

The embodiments of the present disclosure include electronic systems and methods that allow for text input in a virtual environment. The exemplary embodiments use a hand-held controller and a text input processor to input text at suitable locations in the virtual environment based on one or more gestures detected by a touchpad and/or movements of the hand-held controller. Advantageously, the exemplary embodiments allow a user to input text through interacting with a virtual text input interface generated by the text input processor, thereby providing an easy and intuitive approach for text input in virtual environments and improving user experience.

According to an exemplary embodiment of the present disclosure, an electronic system for text input in a virtual environment is provided. The electronic system includes at least one hand-held controller, a detection system to determine the spatial position and/or movement of the at least one hand-held controller, and a text input processor to perform operations. The at least one hand-held controller includes a light blob, a touchpad to detect one or more gestures, and an electronic circuitry to generate electronic instructions corresponding to the gestures. The detection system includes at least one image sensor to acquire one or more images of the at least one hand-held controller and a calculation device to determine the spatial position based on the acquired images. The operations include: receiving the spatial position and/or movement, such as rotation, of the at least one hand-held controller from the detection system; generating an indicator in the virtual environment at a coordinate based on the received spatial position and/or movement of the at least one hand-held controller; entering a text input mode when the indicator overlaps a text field in the virtual environment and upon receiving a trigger instruction from the at least one hand-held controller; receiving the electronic instructions from the at least one hand-held controller; and performing text input operations based on the received electronic instructions in the text input mode.

According to a further exemplary embodiment of the present disclosure, a method for text input in a virtual environment is provided. The method includes receiving, using at least one processor, a spatial position and/or movement of at least one hand-held controller. The at least one hand-held controller includes a light blob, a touchpad to detect one or more gestures, and an electronic circuitry to generate one or more electronic instructions corresponding to the gestures. The method further includes generating, by the at least one processor, an indicator at a coordinate in the virtual environment based on the received spatial position and/or movement of the at least one hand-held controller; entering, by the at least one processor, a text input mode when the indicator overlaps a text field or a virtual button (not shown) in the virtual environment and upon receiving a trigger instruction from the at least one hand-held controller; receiving, by the at least one processor, the electronic instructions from the at least one hand-held controller; and performing, by the at least one processor, text input operations based on the received electronic instructions in the text input mode.

According to a yet further exemplary embodiment of the present disclosure, a method for text input in a virtual environment is provided. The method includes: determining a spatial position and/or movement of at least one hand-held controller. The at least one hand-held controller includes a light blob, a touchpad to detect one or more gestures, and electronic circuitry to generate one or more electronic instructions based on the gestures. The method further includes generating an indicator at a coordinate in the virtual environment based on the spatial position and/or movement of the at least one hand-held controller; entering a standby mode ready to perform text input operations; entering a text input mode from the standby mode upon receiving a trigger instruction from the at least one hand-held controller; receiving the electronic instructions from the at least one hand-held controller; and performing text input operations based on the received electronic instructions in the text input mode.

The details of one or more variations of the subject matter disclosed herein are set forth below and in the accompanying drawings. Other features and advantages of the subject matter disclosed herein will be apparent from the detailed description below, the accompanying drawings, and the claims.

Further modifications and alternative embodiments will be apparent to those of ordinary skill in the art in view of the disclosure herein. For example, the systems and the methods may include additional components or steps that are omitted from the diagrams and description for clarity of operation. Accordingly, the detailed description below is to be construed as illustrative only and is for the purpose of teaching those skilled in the art the general manner of carrying out the present disclosure. It is to be understood that the various embodiments disclosed herein are to be taken as exemplary. Elements and structures, and arrangements of those elements and structures, may be substituted for those illustrated and disclosed herein, objects and processes may be reversed, and certain features of the present teachings may be utilized independently, all as would be apparent to one skilled in the art after having the benefit of the disclosure herein.

### BRIEF DESCRIPTION OF THE DRAWINGS

The accompanying drawings, which are incorporated in and constitute a part of this specification, illustrate exemplary embodiments of the present disclosure, and together with the description, serve to explain the principles of the disclosure.

FIG. 1 is a schematic representation of an exemplary electronic system for text input in a virtual environment, according to embodiments of the present disclosure.

FIG. 2A is a side view for an exemplary hand-held controller of the exemplary electronic system of FIG. 1, according to embodiments of the present disclosure.

FIG. 2B is a top view for the exemplary hand-held controller of FIG. 2A.

FIG. 3 is a schematic representation of an exemplary detection system of the exemplary electronic system of FIG. 1.

FIG. 4 is a schematic representation of an exemplary text input interface generated by the exemplary electronic system of FIG. 1 in a virtual environment.

FIG. 5 is a state diagram illustrating exemplary text input operations performed by the exemplary electronic system of FIG. 1.

FIG. 6 is a state diagram illustrating exemplary text input operations performed by the exemplary electronic system of FIG. 1.

FIG. 7A is a schematic representation of another exemplary text input interface of the exemplary electronic system of FIG. 1.

FIG. 7B is a schematic representation of another exemplary text input interface of the exemplary electronic system of FIG. 1.

FIG. 8 is a state diagram illustrating exemplary text input operations performed by the exemplary electronic system of FIG. 1.

FIG. 9 is a flowchart of an exemplary method for text input in a virtual environment, according to embodiments of the present disclosure.

FIG. 10 is a flowchart of exemplary text input operations in a character-selection mode of the exemplary method of FIG. 9.

FIG. 11 is a flowchart of exemplary text input operations in a string-selection mode of the exemplary method of FIG. 9.

### DETAILED DESCRIPTION OF PREFERRED EMBODIMENTS

This description and the accompanying drawings that illustrate exemplary embodiments should not be taken as limiting. Various mechanical, structural, electrical, and operational changes may be made without departing from the scope of this description and the claims, including equivalents. Similar reference numbers in two or more figures represent the same or similar elements. Furthermore, elements and their associated features that are disclosed in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

The disclosed embodiments relate to electronic systems and methods for text input in a virtual environment created by a virtual reality or augmented reality technology. The virtual environment may be displayed to a user by a suitable electronic device, such as a head-mounted display (e.g., a wearable headset or a see-through head-mounted display), a projector, or a personal computer. Embodiments of the present disclosure may be implemented in a VR system that allows a user to interact with the virtual environment using a hand-held controller.

According to an aspect of the present disclosure, an electronic system for text input in a virtual environment includes a hand-held controller. The hand-held controller may include a light blob that emits visible and/or infrared light. For example, the light blob may emit visible light of one or more colors, such as red, green, and/or blue, and infrared light, such as near infrared light. According to another aspect of the present disclosure, the hand-held controller may include a touchpad that has one or more sensing areas to detect gestures of a user. The hand-held controller may further include electronic circuitry in connection with the touchpad that generates text input instructions based on the gestures detected by the touchpad.

According to another aspect of the present disclosure, a detection system is used to track the spatial position and/or movement of the hand-held controller. The detection system may include one or more image sensors to acquire one or more images of the hand-held controller. The detection system may further include a calculation device to determine the spatial position based on the acquired images. Advantageously, the detection system allows for accurate and automated identification and tracking of the hand-held controller by utilizing the visible and/or infrared light from the light blob, thereby allowing for text input at positions in the virtual environment selected by moving the hand-held controller by the user.

According to another aspect of the present disclosure, the spatial position of the hand-held controller is represented by an indicator at a corresponding position in the virtual environment. For example, when the indicator overlaps a text field or a virtual button in the virtual environment, the text field may be configured to display text input by the user. In such instances, electronic instructions based on gestures detected by a touchpad and/or movement of the hand-held controller may be used for performing text input operations. Advantageously, the use of gestures and the hand-held controller allows the user to input text in the virtual environment at desired locations via easy and intuitive interaction with the virtual environment.

Reference will now be made in detail to embodiments and aspects of the present disclosure, examples of which are illustrated in the accompanying drawings. Where possible, the same reference numbers will be used throughout the drawings to refer to the same or like parts. Those of ordinary skill in the art in view of the disclosure herein will recognize that features of one or more of the embodiments described in the present disclosure may be selectively combined or alternatively used.

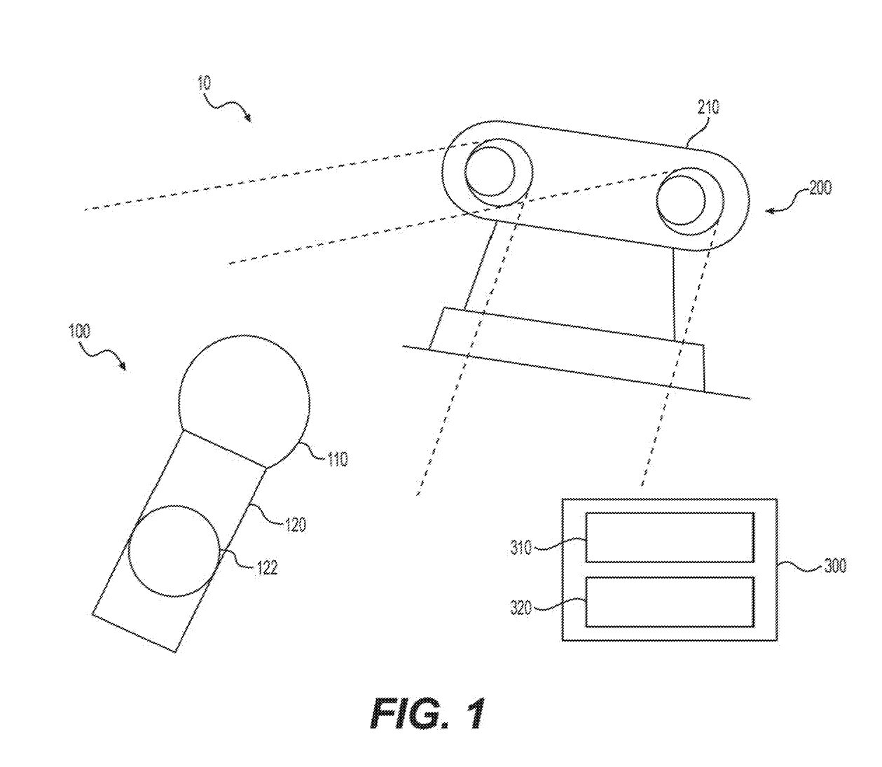

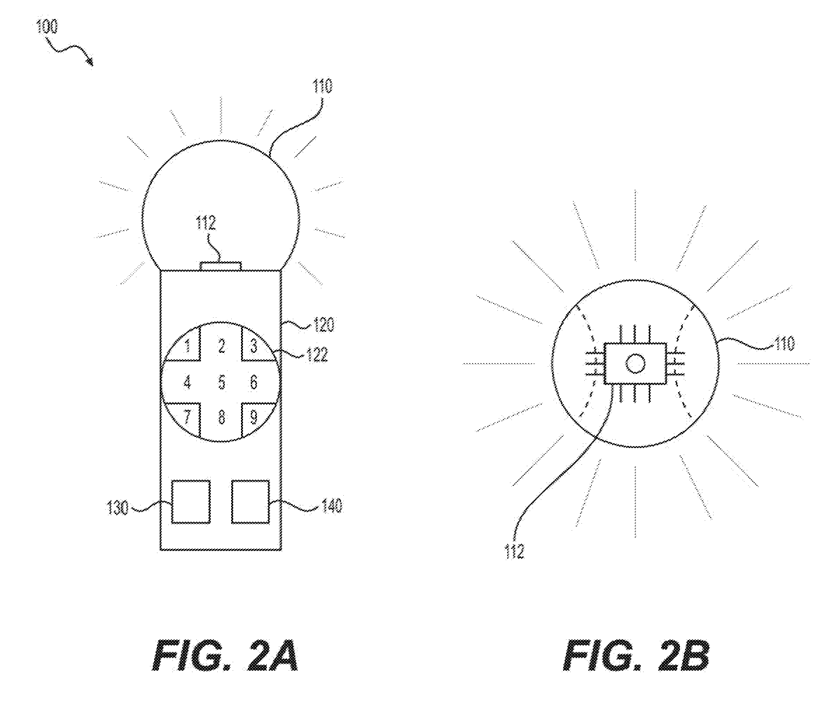

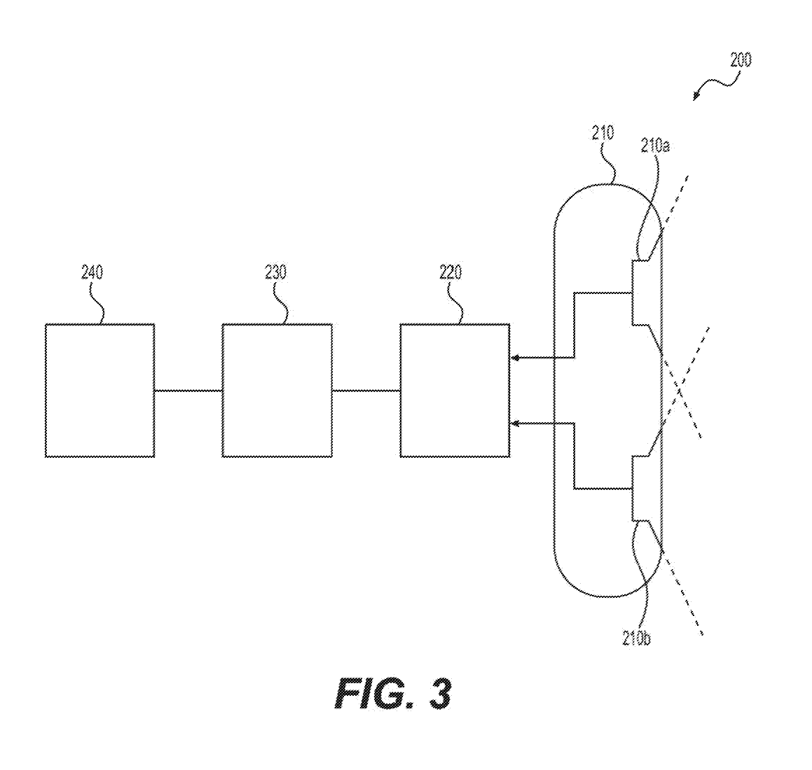

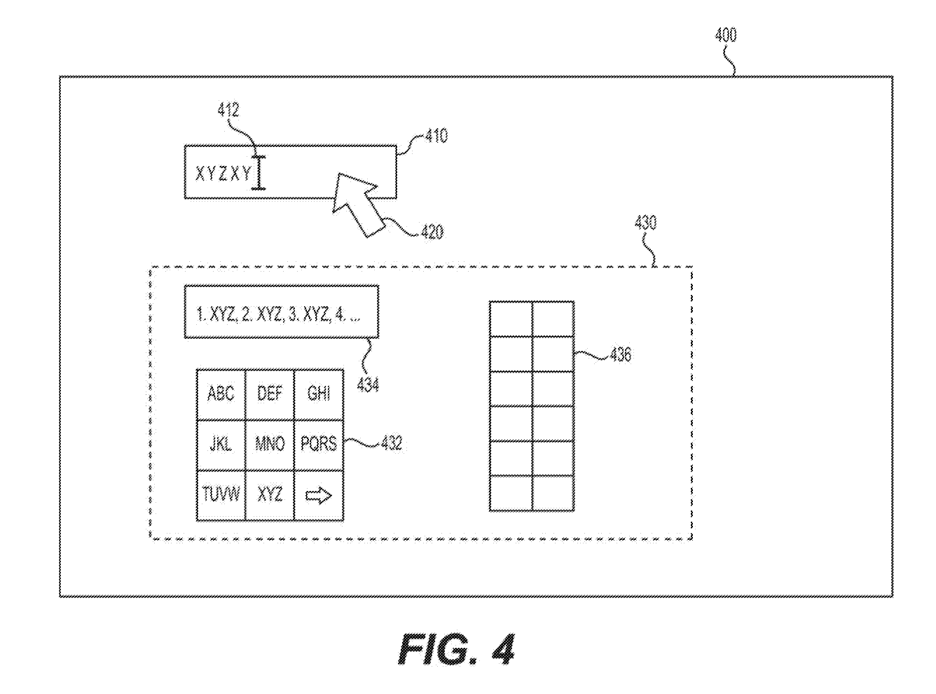

FIG. 1 illustrates a schematic representation of an exemplary electronic system 10 for text input in a virtual environment. As shown in FIG. 1, system 10 includes at least one hand-held controller 100, a detection system 200, and a text input processor 300. Hand-held controller 100 may be an input device for a user to control a video game or a machine, or to interact with the virtual environment, such as a joystick. Hand-held controller 100 may include a light blob 110, a stick 120, and a touchpad 122 installed on stick 120. Detection system 200 may include an image acquisition device 210 having one or more image sensors. Embodiments of hand-held controller 100 and detection system 200 are described below in reference to FIGS. 2 and 3 respectively. Text input processor 300 includes a text input interface generator 310 and a data communication module 320. Text input interface generator 310 may generate one or more text input interfaces and/or display text input by the user in a virtual environment. Data communication module 320 may receive electronic instructions generated by hand-held controller 100, and may receive spatial positions and/or movement data of hand-held controller 100 determined by detection system 200. Operations performed by text input processor 300 using text input interface generator 310 and data communication module 320 are described below in reference to FIGS. 4-8.

FIG. 2A is a side view for hand-held controller 100, and FIG. 2B is a top view for hand-held controller 100, according to embodiments of the present disclosure. As shown in FIGS. 2A and 2B, light blob 110 of hand-held controller 100 may have one or more LEDs (light emitting devices) 112 that emit visible light and/or infrared light and a transparent or semi-transparent cover enclosing the LEDs. The visible light may be of different colors, thereby encoding a unique identification of hand-held controller 100 with the color of the visible light emitted by light blob 110. A spatial position of light blob 110 may be detected and tracked by detection system 200, and may be used for determining a spatial position of hand-held controller 100.

Touchpad 122 includes one or more tactile sensing areas that detect gestures applied by at least one finger of the user. For example, touchpad 122 may include one or more capacitive-sensing or pressure-sensing sensors that detect motions or positions of one or more fingers on touchpad 122, such as tapping, clicking, scrolling, swiping, pinching, or rotating. In some embodiments, as shown in FIG. 2A, touchpad 122 may be divided to a plurality of sensing areas, such as a 3-by-3 grid of sensing areas. Each sensing area may detect the gestures or motions applied thereon. Additionally or alternatively, one or more sensing areas of touchpad 122 may operate as a whole to collectively detect motions or gestures of one or more fingers. For example, touchpad 122 may as a whole detect a rotating or a circular gesture of a finger. For a further example, touchpad 122 may as a whole be pressed down, thereby operating as a functional button. Hand-held controller 100 may further include electronic circuitry (not shown) that converts the detected gestures or motions into electronic signals for text input operations. Text input operations based on the gestures or motions detected by touchpad 122 are described further below in reference to FIGS. 4-8.

In some embodiments, as shown in FIG. 2A, hand-held controller 100 may further include an inertial measurement unit (IMU) 130 that acquires movement data of hand-held controller 100, such as linear motion over three perpendicular axes and/or acceleration about three perpendicular axes (roll, pitch, and yaw). The movement data may be used to obtain position, speed, orientation, rotation, and direction of movement of hand-held controller 100 at a given time. Hand-held controller 100 may further include a communication interface 140 that sends the movement data of hand-held controller 100 to detection system 200. Communication interface 140 may be a wired or wireless connection module, such as a USB interface module, a Bluetooth module (BT module), or a radio frequency module (RF module) (e.g., Wi-Fi 2.4 GHz module). The movement data of hand-held controller 100 may be further processed for determining and/or tracking the spatial position and/or movement (such as lateral or rotational movement) of hand-held controller 100.

FIG. 3 is a schematic representation of detection system 200, according to embodiments of the present disclosure. As shown in FIG. 3, detection system 200 includes image acquisition device 210, an image processing device 220, a calculation device 230, and a communication device 240. Image acquisition device 210 includes one or more image sensors, such as image sensors 210a and 210b. Image sensors 210a and 210b may be CCD or CMOS sensors, CCD or CMOS cameras, high-speed CCD or CMOS cameras, color or gray-scale cameras, cameras with predetermined filter arrays, such as RGB filter arrays or RGB-IR filter arrays, or any other suitable types of sensor arrays. Image sensors 210a and 210b may capture visible light, near-infrared light, and/or ultraviolet light. Image sensors 210a and 210b may each acquire images of hand-held controller 100 and/or light blob 110 at a high speed. In some embodiments, the images acquired by both image sensors may be used by calculation device 230 to determine the spatial position of hand-held controller 100 and/or light blob 110 in a three-dimensional (3-D) space. Alternatively, the images acquired by one image sensor may be used by calculation device 230 to determine the spatial position and/or movement of hand-held controller 100 and/or light blob 110 on a two-dimensional (2-D) plane.

In some embodiments, the images acquired by both image sensors 210a and 210b may be further processed by image processing device 220 before being used for extracting spatial position and/or movement information of hand-held controller 100. Image processing device 220 may receive the acquired images directly from image acquisition device 210 or through communication device 240. Image processing device 220 may include one or more processors selected from a group of processors, including, for example, a microcontroller (MCU), an application-specific integrated circuit (ASIC), a field-programmable gate array (FPGA), a complex programmable logic devices (CPLD), a digital signal processor (DSP), an ARM-based processor, etc. Image processing device 220 may perform one or more image processing operations stored in a non-transitory computer-readable medium. The image processing operations may include denoising, one or more types of filtering, enhancement, edge detection, segmentation, thresholding, dithering, etc. The processed images may be used by calculation device 230 to determine the position of light blob 110 in the processed images and/or acquired images. Calculation device 230 may then determine the spatial position and/or movement of hand-held controller 100 and/or light blob 110 in a 3-D space or on a 2-D plane based on the position of hand-held controller 100 in images and one or more parameters. These parameters may include the focal lengths and/or focal points of the image sensors, the distance between two image sensors, etc.

In some embodiments, calculation device 230 may receive movement data acquired by IMU 130 of FIG. 2A through communication device 240. The movement data may include linear motion over three perpendicular axes and rotational movement, e.g., angular acceleration, about three perpendicular axes (roll, pitch, and yaw) of hand-held controller 100. Calculation device 230 may use the movement data obtained by IMU 130 to calculate the position, speed, orientation, rotation, and/or direction of movement of hand-held controller 100 at a given time. Therefore, calculation device 230 may determine both the spatial position, rotation, and the orientation of hand-held controller 100, thereby improving the accuracy of the representation of the spatial position of hand-held controller 100 in the virtual environments for the determination of text input locations.

FIG. 4 is a schematic representation of an exemplary text input interface 430 in a virtual environment 400. Virtual environment 400 may be created by a VR system or a VR application, and displayed to a user by an electronic device, such as a wearable headset or other display device. As shown in FIG. 4, virtual environment 400 may include one or more text fields 410 for receiving text input. Text input processor 300 of FIG. 1 may generate an indicator 420 at a coordinate in virtual environment 400 based on the spatial position of hand-held controller 100 determined by calculation device 230. Indicator 420 may have a predetermined 3-D or 2-D shape. For example, indicator 420 may have a shape of a circle, a sphere, a polygon, or an arrow. As described herein, text input processor 300 may be part of the VR system or VR application that creates or modifies virtual environment 400.

In some embodiments, the coordinate of indicator 420 in virtual environment 400 changes with the spatial position of hand-held controller 100. Therefore, a user may select a desired text field 410 to input text by moving hand-held controller 100 in a direction such that indicator 420 moves towards the desired text field 410. When indicator 420 overlaps the desired text field 410 in virtual environment 400, text input processor 300 of FIG. 1 may enter a standby mode ready to perform operations to input text in the desired text field 410. Additionally or alternatively, the coordinate of indicator 420 in virtual environment 400 may change with the spatial movement, such as rotation, of hand-held controller 100. For example, movement data indicating rotation or angular acceleration about three perpendicular axes (roll, pitch, and yaw) of hand-held controller 100 may be detected by IMU 130. Calculation device 230 may use the movement data obtained by IMU 130 to determine the orientation, rotational direction, and/or angular acceleration of hand-held controller 100. Thus, the rotational movement of hand-held controller 100 can be used to determine the coordinate of indicator 420 in virtual environment 400.

As described herein, a current coordinate of indicator 420 in virtual environment 400 based on the spatial position and/or movement of hand-held controller 100 can be determined based on a selected combination of parameters. For example, one or more measurements of the spatial position, orientation, linear motion, and/or rotation may be used to determine a corresponding coordinate of indicator 420. This in turn improves the accuracy of the representation of the spatial position of hand-held controller 100 by the coordinate of indicator 420 in virtual environment 400.

In some embodiments, a user may select a desired text field 410 to input text by moving hand-held controller 100 in a direction such that indicator 420 overlaps a virtual button (not shown), such as a virtual TAB key, in virtual environment 400. Additionally or alternatively, a trigger instruction may be generated by a gesture, such as a clicking, sliding, or tapping gesture for selecting desired text field 410 for text input. The clicking, sliding, or tapping gesture can be detected by touchpad 122 of hand-held controller 100.

In the standby mode, upon receiving a trigger instruction, text input processor 300 may enter a text input mode, in which text input interface generator 310 of FIG. 1 may generate a cursor 412 in the desired text field 410 and generate text input interface 430 in virtual environment 400. Text input interface generator 310 may then display text input by the user before cursor 412. In some embodiments, the trigger instruction may be generated by a gesture, such as a clicking, sliding, or tapping gesture for selecting a character, detected by touchpad 122 of hand-held controller 100 illustrated in FIG. 2A and received by text input processor 300 via data communication module 320 of FIG. 1. In other embodiments, the trigger instruction may be generated by the movement of hand-held controller 100, such as a rotating, leaping, tapping, rolling, tilting, jolting, or other suitable movement of hand-held controller 100.

In some embodiments, when indicator 420 moves away from text field 410 or a virtual button, e.g., due to movement of hand-held controller 100, text input processor 300 may remain in the text input mode. However, when further operations are performed while indicator 420 is away from text field 410, text input processor 300 may exit the text input mode.

Exemplary text input operations performed by text input processor 300 based on the exemplary embodiment of text input interface 430 of FIG. 4 are described in detail below in reference to FIGS. 4-6.

As shown in FIG. 4, an exemplary embodiment of text input interface 430 may include a first virtual interface 432 to display one or more characters and a second virtual interface 434 to display one or more candidate text strings. First virtual interface 432 may display a plurality of characters, such as letters, numbers, symbols, and signs. In one exemplary embodiment, as shown in FIG. 4, first virtual interface 432 is a virtual keypad having a 3-by-3 grid layout of a plurality of virtual keys. A virtual key of the virtual keypad may be associated with a number from 1 to 9, a combination of characters, punctuations, and/or suitable functional keys, such as a Space key or an Enter key. In such instances, first virtual interface 432 serves as a guide for a user to generate text strings by selecting the numbers, characters, punctuations, and/or spaces based on the layout of the virtual keypad. For example, the sensing areas of touchpad 122 of FIG. 2A may have a corresponding 3-by-3 grid layout such that a gesture of the user detected by a sensing area of touchpad 122 may generate an electronic instruction for text input processor 300 to select one of the characters in the corresponding key in first virtual interface 432.

First virtual interface 432 may select to use any suitable types or layouts of virtual keypads, and not limited to the examples described herein. Instructions to select and/or input text strings or text characteristics may be generated by various interactive movements of handheld controller 100 suitable for the selected type or layout of virtual keypad. In some embodiments, first virtual interface 432 may be a ray-casting keyboard where one or more rays simulating laser rays may be generated and pointed towards keys in the virtual keyboard in virtual environment 400. Changing the orientation and/or position of handheld controller 100 may direct the laser rays to keys that have the desired characters. Additionally or alternatively, one or more virtual drumsticks or other visual indicators may be generated and pointed towards keys in the virtual keyboard in virtual environment 400. Changing the orientation and/or position of handheld controller 100 may direct the drumsticks to touch or tap onto keys that have the desired characters. In other embodiments, first virtual interface 432 may be a direct-touching keyboard displayed on a touch screen or surface. Clicking or tapping of the keys in the keyboard allows for the selection of the desired characters represented by the keys.

Second virtual interface 434 may display one or more candidate text strings based on the characters selected by the user from first virtual interface 432 (The exemplary candidate text strings “XYZ” shown in FIG. 4 may represent any suitable text string). First virtual interface 432 and second virtual interface 434 may not be displayed at the same time. For example, when text input processor 300 is in the standby mode, upon receiving a trigger instruction, text input processor 300 may enter the text input mode, where text input interface generator 310 generates first virtual interface 432 in virtual environment 400. Text input interface generator 310 may also generate second virtual interface 434 of in virtual environment 400 and display second virtual interface 434 and first virtual interface 432 in virtual environment 400 substantially at the same time.

In some embodiments, text input interface 430 may include a third virtual interface 436. Third virtual interface 436 may include one or more functional keys, such as modifier keys, navigation keys, and system command keys, to perform functions, such as switching between lowercase and uppercase or switching between traditional or simplified characters. A functional key in third virtual interface 436 may be selected by moving indicator 420 towards the key such that indicator 420 overlaps the selected key. In such instances, the function of the selected key may be activated when text input processor 300 receives an electronic instruction corresponding to a clicking, sliding, or tapping gesture detected by touchpad 122. Other suitable gestures may be used to select a suitable functional key in third virtual interface 436. For example, the electronic instruction for activating a functional key in third virtual interface 436 may be generated by pressing a control button (not shown) on hand-held controller 100.

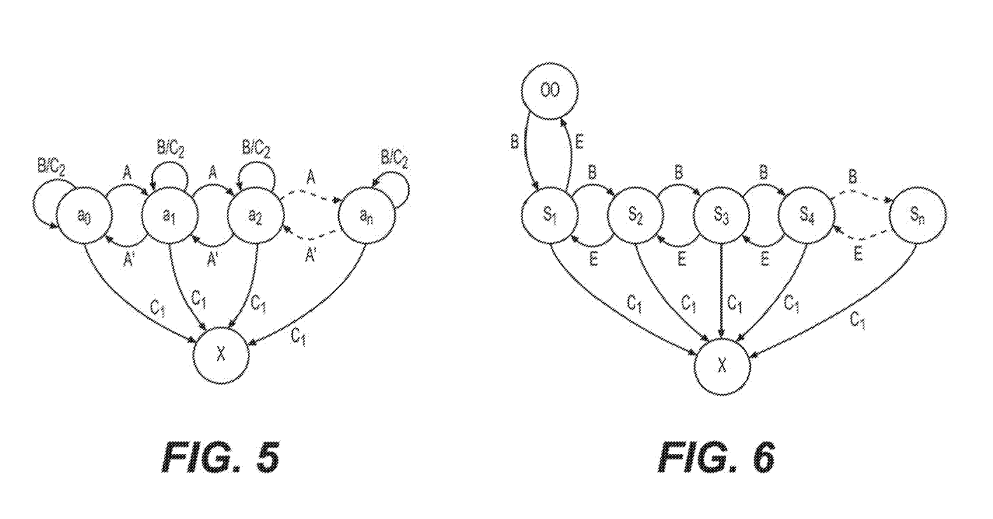

FIGS. 5 and 6 are state diagrams illustrating exemplary text input operations performed by text input processor 300 of FIG. 1 based on the exemplary embodiment of text input interface 430 of FIG. 4. The text input mode of text input processor 300 may include a character-selection mode and a string-selection mode, which are described in detail below in reference to FIGS. 5 and 6.

As shown in FIG. 5, in some embodiments, text input processor 300 may have a plurality of operational states with respect to first virtual interface 432, represented by a₀ to aₙ. Text input processor 300 operates in states a₀ to aₙ in the character-selection mode, where first virtual interface 432 is activated and responds to the electronic instructions received from hand-held controller 100. The state X shown in FIG. 5 represents the string-selection mode of text input processor 300, where second virtual interface 434 is activated and responds to the electronic instructions received from hand-held controller 100. Text input processor 300 may switch between these operational states based on electronic instructions received from hand-held controller 100.

In some embodiments, states a₀ to aₙ correspond to different layouts or types of the virtual keypad. The description below uses a plurality of 3-by-3 grid layouts of the keypad as an example. Each grid layout of first virtual interface 432 may display a different set of characters. For example, a first grid layout in state a₀ may display the Latin alphabets, letters of other alphabetical languages, or letters or root shapes of non-alphabetical languages (e.g., Chinese), a second grid layout in state a₁ may display numbers from 0 to 9, and a third grid layout in state a₂ may display symbols and/or signs. In such instances, a current grid layout for text input may be selected from the plurality of grid layouts of first virtual interface 432 based on one or more electronic instructions from hand-held controller 100.

In some embodiments, text input interface generator 310 may switch first virtual interface 432 from a first grid layout in state a₀ to a second grid layout in state a₁ based on an electronic instruction corresponding to a first sliding gesture detected by touchpad 122. For example, the first sliding gesture, represented by A in FIG. 5, may be a gesture sliding horizontally from left to right or from right to left. Text input interface generator 310 may further switch the second grid layout in state a₁ to a third grid layout in state a₂ based on another electronic instruction corresponding to the first sliding gesture, A, detected by touchpad 122.

Additionally, as shown in FIG. 5, text input interface generator 310 may switch the third grid layout in state a₂ back to the second grid layout in state a₁ based on an electronic instruction corresponding to a second sliding gesture detected by touchpad 122. The second sliding gesture, represented by A′ in FIG. 5, may have an opposite direction from that of the first sliding gesture, A. For example, the second sliding gesture, A′, may be a gesture sliding horizontally from right to left or left to right. Text input interface generator 310 may further switch the second grid layout in state a₁ back to the first grid layout in state a₀ based on another electronic instruction corresponding to the second sliding gesture, A′, detected by touchpad 122.

In each of the states a₀ to aₙ, one of the grid layouts of first virtual interface 432 is displayed, and a character may be selected for text input by selecting the key having that character in the virtual keypad. For example, the sensing areas of touchpad 122 may have a corresponding 3-by-3 grid keypad layout such that a character-selection gesture of the user detected by a sensing area of touchpad 122 may generate an electronic instruction for text input processor 300 to select one of the characters in the corresponding key in first virtual interface 432. The character-selection gesture, represented by B in FIG. 5, may be a clicking or tapping gesture. Upon receiving the electronic instruction corresponding to the character-selection gesture, as shown in FIG. 5, text input interface generator 310 may not change the current grid layout of first virtual interface 432, allowing the user to continue selecting one or more characters from the current layout.

As described herein, text input processor 300 may switch between the operational states a₀ to aₙ in the character-selection mode based on electronic instructions received from hand-held controller 100, such as the sliding gestures described above. Alternatively, electronic instructions from hand-held controller 100 may be generated based on the movement of hand-held controller 100. Such movement may include rotating, leaping, tapping, rolling, tilting, jolting, or other suitable movement of hand-held controller 100.

Advantageously, in the character-selection mode of text input processor 300, a user may select one or more characters from one or more grid layouts of first virtual interface 432 by applying intuitive gestures on touchpad 122 while being immersed in virtual environment 400. Text input interface generator 310 may display one or more candidate text strings in second virtual interface 434 based on the characters selected by the user.

Text input processor 300 may switch from the character-selection mode to the string-selection mode when one or more candidate text strings are displayed in second virtual interface 434. For example, based on an electronic instruction corresponding to a third sliding gesture detected by touchpad 122, text input processor 300 may switch from any of the states a₀ to aₙ to state X, where second virtual interface 434 is activated for string selection. The third sliding gesture, represented by C₁ in FIG. 5, may be a gesture sliding vertically from the top to the bottom or from the bottom to the top on touchpad 122. The direction of the third sliding gesture is orthogonal to that of the first or second sliding gesture. In some embodiments, when no strings are displayed in second virtual interface 434, text input processor 300 may not switch from the character-selection mode to the string-selection mode. In this instance, the third gesture is represented C₂ in FIG. 5, and text input processor 300 remain in the current state and does not switch to state X, and first virtual interface 432 remain in the current grid layout.

FIG. 6 illustrates a plurality of operational states of text input processor 300 with respect to second virtual interface 434. Text input processor 300 operates in states S₁ to Sₙ in the string-selection mode, where the number of candidate text strings displayed in second virtual interface 434 ranges from 1 to n. For example, as shown in FIG. 4, a plurality of candidate text strings generated based on the characters selected by the user are numbered and displayed in second virtual interface 434. In state 00, second virtual interface 434 is not shown, is closed, or displays no candidate text strings. The state X represents the string-selection mode of text input processor 300, where second virtual interface 434 is activated and responds to the electronic instructions received from hand-held controller 100. Text input processor 300 may switch between these operational states based on electronic instructions received from hand-held controller 100.

As shown in FIG. 6, text input processor 300 may switch from state 00 to state S₁, from state S₁ to state S₂, from state Sₙ₋₁ to state Sₙ and so forth when a character-selection gesture, represented by B in FIG. 6, of the user is detected by a sensing area of touchpad 122. As described above, the character-selection gesture, B, may be a clicking or tapping gesture. In such instances, text input interface generator 310 may update the one or more candidate text strings in second virtual interface 434 based on one or more additional characters selected by the user. Additionally or alternatively, when an operation of deleting a character from the candidate text strings is performed, represented by E in FIG. 6, text input processor 300 may switch from state S₁ to state 00, from state S₂ to state S₁, from state Sₙ to state Sₙ₋₁, and so forth. For example, text input interface generator 310 may delete a character in each of the candidate text strings displayed in second virtual interface 434 based on an electronic instruction corresponding to a backspace operation. The electronic instruction corresponding to a backspace operation may be generated, for example, by pressing a button on hand-held controller 100 or selecting one of the functional keys of third virtual interface 436.

Text input processor 300 may switch from any of states S₁ to Sₙ to state X, i.e., the string-selection mode, based on an electronic instruction corresponding to the third sliding gesture, C1, detected by touchpad 122. In state X, second virtual interface 434 is activated for string selection. However, in state 00, when no strings are displayed in second virtual interface 434 or when second virtual interface 434 is closed, text input processor 300 may not switch from state 00 to state X.

As described herein, text input processor 300 may switch between the operational states S₁ to Sₙ in the string-selection mode based on electronic instructions received from hand-held controller 100. As described above, electronic instructions from hand-held controller 100 may be generated based on the gestures detected by touchpad 122 and/or movement of hand-held controller 100. Such movement may include rotating, leaping, tapping, rolling, tilting, jolting, or other types of intuitive movement of hand-held controller 100.

In some embodiments, when text input processor 300 is in state X or operates in the string-selection mode, a selection of the sensing areas of the 3-by-3 grid layout of touchpad 122 and/or a selection of the virtual keys of first virtual interface 432 may each be assigned a number, e.g., a number selected from 1 to 9. As shown in FIG. 4, candidate text strings displayed in second virtual interface 434 may also be numbered. A desired text string may be selected by a user by clicking or tapping a sensing area or sliding on a sensing area of touchpad 122 assigned with the same number. The selected text string may be removed from the candidate text strings in second virtual interface 434, and the numbering of the remaining candidate text strings may then be updated. When all candidate text strings are selected and/or removed, text input interface generator 310 may close second virtual interface 434, and may return to state 00.

In some embodiments, more than one desired text strings may be selected in sequence from the candidate text strings displayed in second virtual interface 434. Additionally or alternatively, one or more characters may be added to or removed from the candidate text strings after a desired text string is selected. In such instances, text input interface generator 310 may update the candidate text strings and/or the numbering of the candidate text strings displayed in second virtual interface 434. As shown in FIG. 4, the selected one or more text strings may be displayed or inserted by text input interface generator 310 before cursor 412 in text field 410 in virtual environment 400. Cursor 412 may move towards the end of text field 410 as additional strings are selected.

In some embodiments, when second virtual interface 434 is closed or deactivated, e.g., based on an electronic instruction corresponding to a gesture detected by touchpad 122, a user may edit the text input already in text field 410. For example, when an electronic instruction corresponding to a backspace operation is received, text input interface generator 310 may delete a character in text field 410 before cursor 412, e.g., a character Z in the text string XYZ, as shown in FIG. 4. Additionally or alternatively, when an electronic instruction corresponding to a navigation operation is received, text input interface generator 310 may move cursor 412 to a desired location between the characters input in text field 410 to allow further insertion or deletion operations.

As described herein, the operational states of text input processor 300 described in reference to FIGS. 5 and 6 may be switched using one or more control buttons (not shown) on hand-held controller 100 or based one movements of hand-held controller 100 in addition to or as an alternative approach of the above-described gestures applied to touchpad 122 by a user.

In some embodiments, two hand-held controllers 100 may be used to increase the efficiency and convenience to perform the above-described text input operations by a user. For example, text input interface 430 may include two first virtual interfaces 432, each corresponding to a hand-held controller 100. One hand-held controller 100 may be used to input text based on a first 3-by-3 grid layout of first virtual interfaces 432 while the other hand-held controller 100 may be used to input text based on a second 3-by-3 grid layout. Alternatively, one hand-held controller 100 may be used to select one or more characters based on first virtual interfaces 432 while the other hand-held controller 100 may be used to select one or more text strings from second virtual interfaces 434.

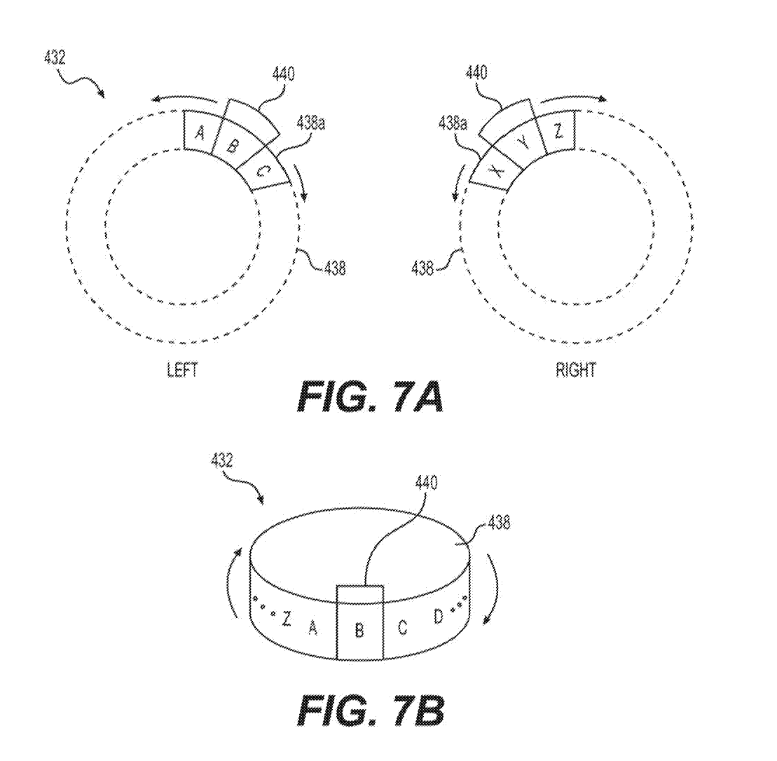

FIGS. 7A and 7B are schematic representations of other exemplary embodiments of first virtual interface 432. First virtual interface 432 may have a 2-D circular keypad 438 as shown in FIG. 7A or a 3D circular keypad 438 in a cylindrical shape as shown in FIG. 7B.

As shown in FIGS. 7A and 7B, circular keypad 438 may have a plurality of virtual keys 438a arranged along its circumference and each virtual key 438a may represent one or more characters. For example, circular keypad 438 may have a selected number of keys distributed around the circumference with each virtual key 438a representing an alphabet of an alphabetical language, such as Latin alphabet from A to Z in English or Russian, or a letter or root of a non-alphabetical language, such as Chinese, or Japanese. Alternatively, circular keypad 438 may have a predetermined number of virtual keys 438a, each representing a different character or a different combination of characters, such as letters, numbers, symbols, or signs. The type and/or number of characters in each virtual key 438a may be predetermined based on design choices and/or human factors.

As shown in FIGS. 7A and 7B, circular keypad 438 may further include a pointer 440 for selecting a virtual key 438a. For example, a desired virtual key may be selected when pointer 440 overlaps and/or highlights the desired virtual key. One or more characters represented by the desired virtual key may then be selected by text input processor 300 upon receiving an electronic instruction corresponding to a gesture, such as a clicking, sliding, or tapping, detected by touchpad 122. In some embodiments, circular keypad 438 of first virtual interface 432 may include a visible portion and a nonvisible portion. As shown in FIG. 7A, the visible portion may display one or more virtual keys near pointer 440. Making a part of circular keypad 438 invisible may save the space text input interface 430 occupies in virtual environment 400, and/or may allow circular keypad 438 to have a greater number of virtual keys 438a while providing a simple design for character selection by the user.

A character may be selected from circular keypad 438 based on one or more gestures applied on touchpad 122 of hand-held controller 100. For example, text input processor 300 may receive an electronic instruction corresponding to a circular motion applied on touchpad 122. The circular motion may be partially circular. Electronic circuitry of hand-held controller 100 may convert the detected circular or partially circular motions into an electronic signal that contains the information of the direction and traveled distance of the motion. Text input interface generator 310 may rotate circular keypad 438 in a clockwise direction or a counterclockwise direction based on the direction of the circular motion detected by touchpad 122. The number of virtual keys 438a traversed during the rotation of circular keypad 438 may depend on the traveled distance of the circular motion. Accordingly, circular keypad 438 may rotate as needed until pointer 440 overlaps or selects a virtual key 438a representing one or more characters to be selected. When text input processor 300 receives an electronic instruction corresponding to a clicking, sliding, or tapping gesture detected by touchpad 122, one or more characters from the selected virtual key may be selected to add to the candidate text strings.

Two circular keypads 438, each corresponding to a hand-held controller 100, may be used to increase the efficiency and convenience to perform text input operations by a user. In some embodiments, as shown in FIG. 7A, a left circular keypad 438 and a left hand-held controller 100 may be used for selecting letters from A to M while a right circular keypad 438 and a right hand-held controller 10 may be used to select letters from N to Z. In other embodiments, the left circular keypad 438 and left hand-held controller 100 may be used to select Latin alphabets while the right circular keypad 438 and right hand-held controller 10 may be used to select numbers, symbols or signs. In other embodiments, the left circular keypad 438 and left hand-held controller 100 may be used to select characters while the right circular keypad 438 and right hand-held controller 10 may be used to select candidate text strings displayed in second virtual interface 434 to input to text field 410.

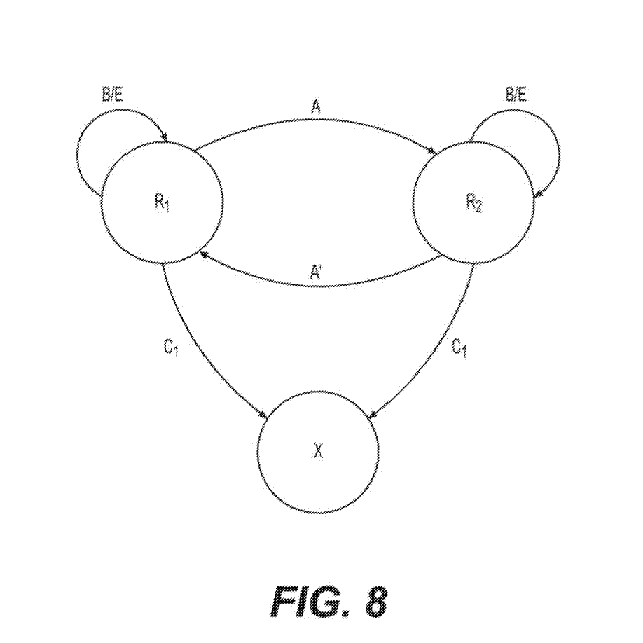

FIG. 8 is a state diagram illustrating exemplary text input operations performed by text input processor 300 based on the exemplary embodiments of first virtual interface 432 of FIGS. 7A and 7B.

As shown in FIG. 8, text input processor 300 may have a plurality of operational states with respect to first virtual interface 432 having the layout of a circular virtual keypad 438. Two exemplary operational states in the character-selection mode of text input processor 300 are represented by states R₁ and R₂, where first virtual interface 432 is activated and responds to the electronic instructions received from hand-held controller 100. In state R₁, pointer 440 overlaps a first virtual key of circular keypad 438 while in state R₂, pointer 440 overlaps a second virtual key of circular keypad 438. Text input processor 300 may switch between state R₁ and state R₂ based on electronic instructions corresponding to circular gestures detected by touchpad 122 as described above in reference to FIGS. 7A and 7B.

Similarly as in FIGS. 5 and 6, state X shown in FIG. 8 represents a string-selection mode of text input processor 300, where second virtual interface 434 is activated and responds to the electronic instructions received from hand-held controller 100. Text input processor 300 may switch from any of states R₁ and R₂ in the character-selection mode to state X or the string-selection mode based on an electronic instruction corresponding to the third sliding gesture, represented by C₁, detected by touchpad 122, as described above in reference to in FIGS. 5 and 6. When text input processor 300 is in state X or operates in the string-selection mode, the selection of one or more text strings for input in text field 410 may be similarly performed as described above for operations performed in state X.

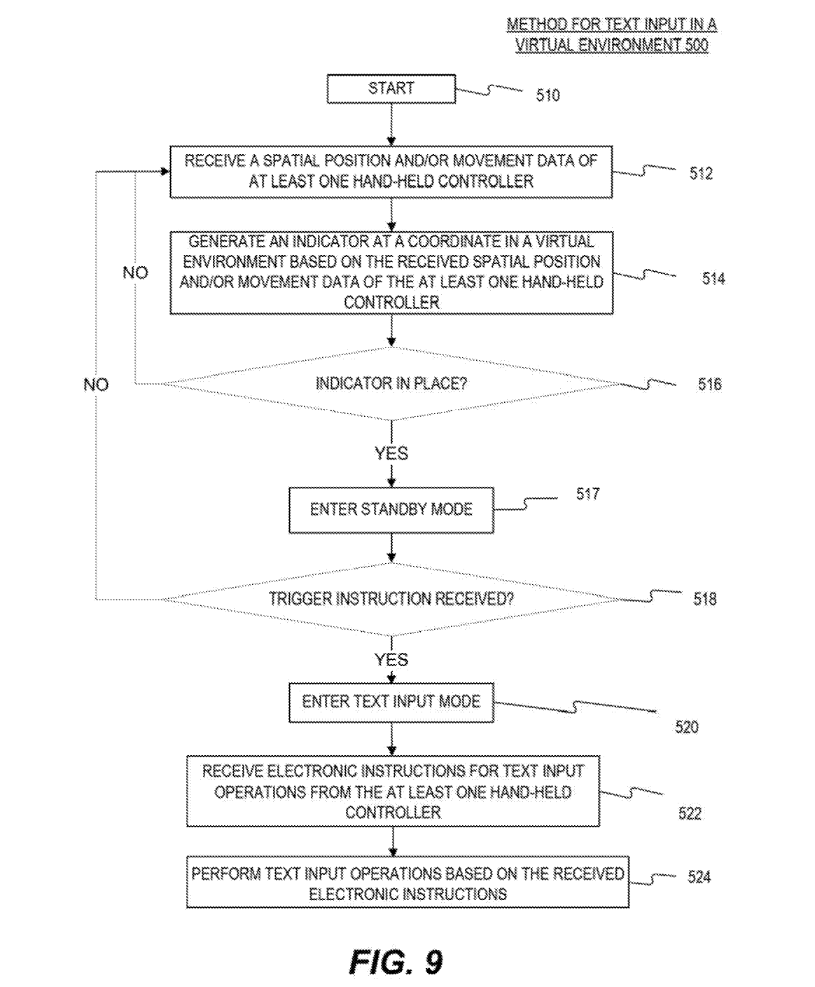

System 10 of FIG. 1 as described herein may be utilized in a variety of methods for text input in a virtual environment. FIG. 9 is a flowchart of an exemplary method 500 for text input in a virtual environment, according to embodiments of the present disclosure. Method 500 uses system 10 and features of the embodiments of system 10 described above in reference to FIGS. 1-8. In some embodiments, method 500 may be performed by system 10. In other embodiments, method 500 may be performed by a VR system including system 10.

As shown in FIG. 9, in step 512, text input processor 300 of FIG. 1 may receive the spatial position of at least one hand-held controller 100 of FIG. 1 from detection system 200 of FIG. 1. For example, data communication module 320 of text input processor 300 may receive the spatial position from communication device 240 of detection system 200. As described previously, calculation device 230 of detection system 200 may determine and/or track the spatial position of one or more hand-held controllers 100 based on one or more images acquired by image sensors 210a and 210b and/or movement data acquired by IMU 130 of handheld controller. The movement data may be sent by communication interface 140 of hand-held controller 100 and received by communication device 240 of detection system 200.

In step 514, text input processor 300 may generate indicator 420 at a coordinate in virtual environment 400 of FIG. 4 based on the received spatial position and/or movement of hand-held controller 100. In step 516, text input processor 300 determines whether the indicator 420 overlaps a text field 410 or a virtual button in virtual environment 400. For example, text input processor 300 may compare the coordinate of indicator 420 in virtual environment 400 with that of text field 410 and determine whether indicator 420 falls within the area of text field 410. If indicator 420 does not overlap text field 410, text input processor 300 may return to step 512.

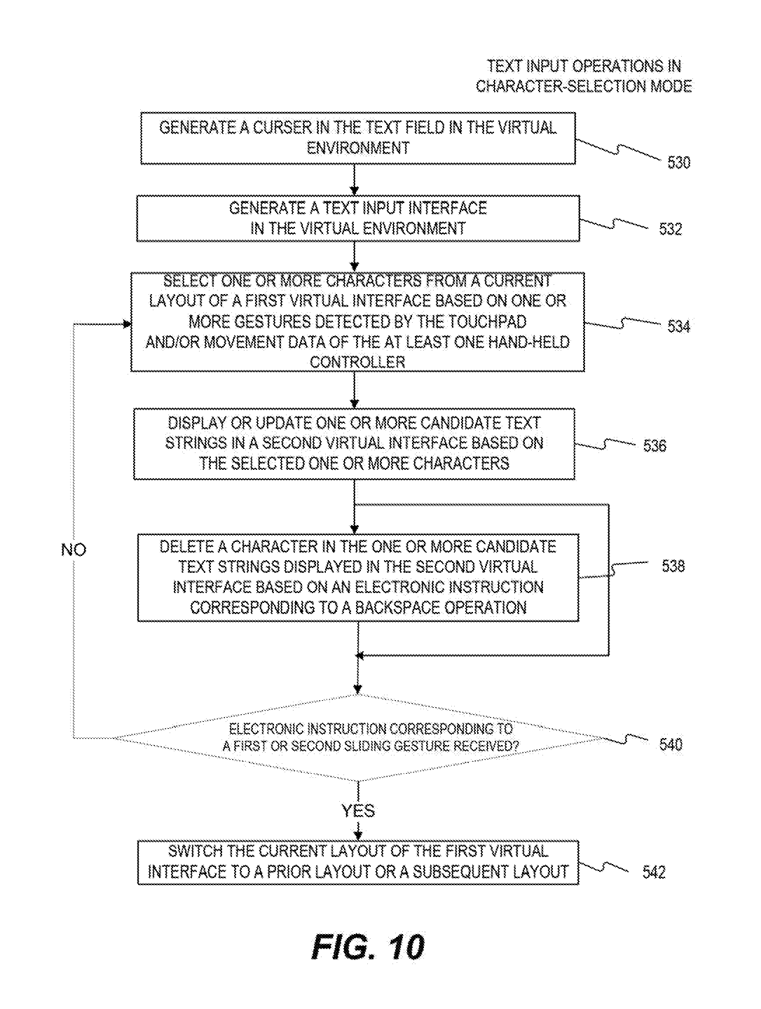

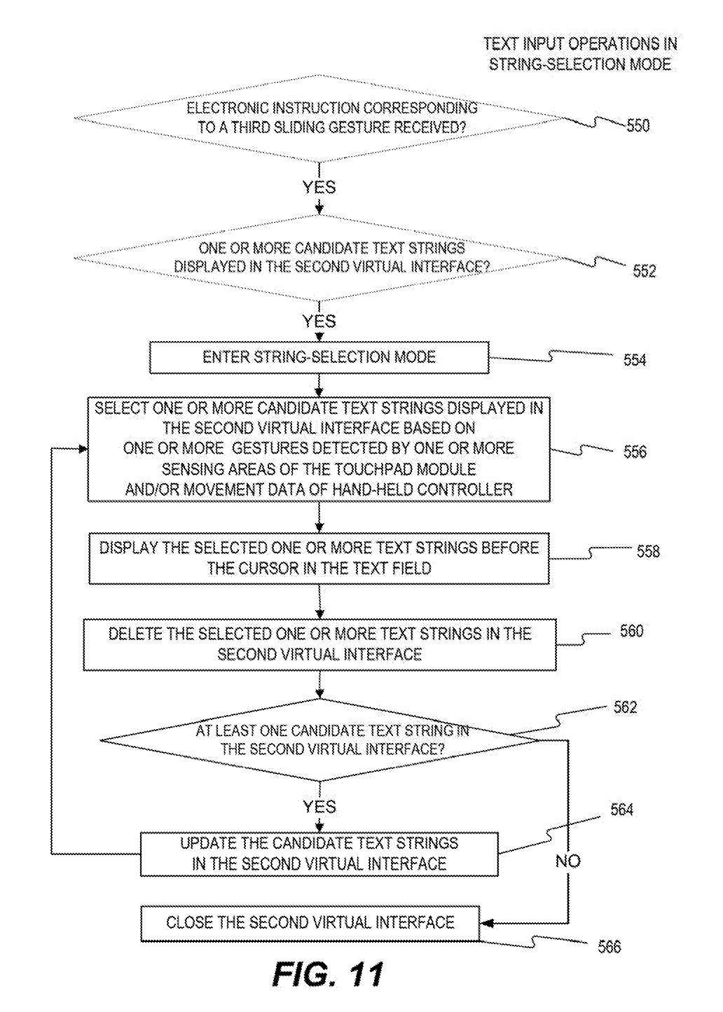

In some embodiments, when indicator 420 overlaps text field 410, text input processor 300 may proceed to step 517 and enter a standby mode ready to perform operations to enter text in text field 410. In step 518, text input processor 300 determines whether a trigger instruction, such as an electronic signal corresponding to a tapping, sliding, or clicking gesture detected by touchpad 122 of hand-held controller 100 has been received via data communication module 320. If a trigger instruction is not received by text input processor 300, text input processor 300 may stay in the standby mode to await the trigger instruction or return to step 512. In step 520, when text input processor 300 receives the trigger instruction, text input processor 300 may enter a text input mode. Operating in the text input mode, in steps 522 and 524, text input processor 300 may proceed to receive further electronic instructions and perform text input operations in the text input mode. The electronic instructions may be sent by communication interface 140 of hand-held controller 100 and received via data communication module 320. The text input operations may further include the steps as described below in reference to FIGS. 10 and 11 respectively.

FIG. 10 is a flowchart of exemplary text input operations in a character-selection mode of the exemplary method 500 of FIG. 9. As shown in FIG. 10, in step 530, text input processor 300 may generate cursor 412 in text field 410 in virtual environment 400. In step 532, text input processor 300 may generate text input interface 430 in virtual environment 400. Text input interface 430 may include a plurality of virtual interfaces for text input, such as first virtual interface 432 for character selection, second virtual interface 434 for string selection, and third virtual interface 436 for functional key selection. One or more of the virtual interfaces may be displayed in step 530.

In step 534, text input processor 300 may make a selection of a character based on an electronic instruction corresponding to a gesture detected by touchpad 122 and/or movement of hand-held controller 100. The electronic instruction may be sent by communication interface 140 and received by data communication module 320. In some embodiments, text input processor 300 may select a plurality of characters from first virtual interface 432 based on a series of electronic instructions. In some embodiments, one or more functional keys of third virtual interface 436 may be activated prior to or between the selection of one or more characters.

When at least one character is selected, text input processor 300 may perform step 536. In step 536, text input processor 300 may display one or more candidate text strings in second virtual interface 434 based on the selected one or more characters in step 534. In some embodiments, text input processor 300 may update the candidate text strings already in display in second virtual interface 434 based on the selected one or more characters in step 534. Upon receiving an electronic instruction corresponding to a backspace operation, in step 538, text input processor 300 may delete a character in the candidate text strings displayed in second virtual interface 434. Text input processor 300 may repeat or omit step 538 depending on the electronic instructions sent by hand-held controller 100.

In step 540, text input processor 300 may determine whether an electronic instruction corresponding to a gesture applied on touchpad 122 for switching the current layout of first virtual interface 432 is received. If not, text input processor 300 may return to step 534 to continue to select one or more characters. If an electronic instruction corresponding to a first sliding gesture is received, in step 542, text input processor 300 may switch the current layout of first virtual interface 432, such as a 3-by-3 grid layout, to a prior layout. Alternatively, if an electronic instruction corresponding to a second sliding gesture is received, text input processor 300 may switch the current layout of first virtual interface 432 to a subsequent layout. The direction of the first sliding gesture is opposite to that of the second sliding gesture. For example, the direction of the first sliding gesture may be sliding from right to left horizontally while the direction of the second sliding gesture may be sliding from left to right horizontally, or vice versa.

FIG. 11 is a flowchart of exemplary text input operations in a string-selection mode of the exemplary method 500 of FIG. 9. In step 550, as shown in FIG. 11, text input processor 300 may determine whether an electronic instruction corresponding to a gesture on touchpad 122 and/or movement of hand-held controller 100 for switching from the character-selection mode to the string-selection mode is received. In step 552, upon receiving an electronic instruction corresponding to a third sliding gesture detected by touchpad 122, text input processor 300 may determine whether there are one or more candidate text strings are displayed in second virtual interface 434. If yes, text input processor 300 may proceed to step 554 and enter string-selection mode, where second virtual interface 434 is activated and responds to the electronic instructions received from hand-held controller 100 for string selection.

In step 556, text input processor 300 may make a selection of a text string from the candidate text strings in second virtual interface 434 based on an electronic instruction corresponding to a gesture detected by touchpad 122 and/or movement of hand-held controller 100. The electronic instruction may be sent by communication interface 140 and received by data communication module 320. As described above, touchpad 122 may have one or more sensing areas, and each sensing area may be assigned a number corresponding to a candidate text string displayed in second virtual interface 434. In some embodiments, text input processor 300 may select a plurality of text strings in step 556.

In step 558, text input processor 300 may display the selected one or more text strings in text field 410 in virtual environment 400. The text strings may be displayed before cursor 412 in text field 410 such that cursor 412 moves towards the end of text field 410 as more text strings are added. In some embodiments, in step 560, the selected text strings are deleted from the candidate text strings in second virtual interface 434. In step 562, text input processor 300 may determine whether there is at least one candidate text string in second virtual interface 434. If yes, text input processor 300 may proceed to step 564 to update the remaining candidate text strings and/or their numbering. After the update, text input processor 300 may return to step 556 to select more text strings to input to text field 410. Alternatively, text input processor 300 may switch back to character-selection mode based on an electronic instruction generated by a control button or a sliding gesture received from hand-held controller 100, for example. If no candidate text strings remains, text input processor 300 may proceed to step 566, where text input processor 300 may close second virtual interface 434. Text input processor 300 may return to character-selection mode or exit text input mode after step 566.

As described herein, the sequence of the steps of method 500 described in reference to FIGS. 9-11 may change, and may be performed in various exemplary embodiments as described above in reference to FIGS. 4-8. Some steps of method 500 may be omitted or repeated, and/or may be performed simultaneously.

A portion or all of the methods disclosed herein may also be implemented by an application specific integrated circuit (ASIC), a field-programmable gate array (FPGA), a complex programmable logic device (CPLD), a printed circuit board (PCB), a digital signal processor (DSP), a combination of programmable logic components and programmable interconnects, single central processing unit (CPU) chip, a CPU chip combined on a motherboard, a general purpose computer, or any other combination of devices or modules capable of providing text input in a virtual environment disclosed herein.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware or software alone. In addition, while certain components have been described as being coupled or operatively connected to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

Instructions or operational steps stored by a computer-readable medium may be in the form of computer programs, program modules, or codes. As described herein, computer programs, program modules, and code based on the written description of this specification, such as those used by the controller, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

In some aspects, methods consistent with disclosed embodiments may exclude disclosed method steps, or may vary the disclosed sequence of method steps or the disclosed degree of separation between method steps. For example, method steps may be omitted, repeated, or combined, as necessary, to achieve the same or similar objectives. In various aspects, non-transitory computer-readable media may store instructions for performing methods consistent with disclosed embodiments that exclude disclosed method steps, or vary the disclosed sequence of method steps or disclosed degree of separation between method steps. For example, non-transitory computer-readable media may store instructions for performing methods consistent with disclosed embodiments that omit, repeat, or combine, as necessary, method steps to achieve the same or similar objectives. In certain aspects, systems need not necessarily include every disclosed part, and may include other undisclosed parts. For example, systems may omit, repeat, or combine, as necessary, parts to achieve the same or similar objectives.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. An electronic system for text input in a virtual environment, comprising:
at least one hand-held controller comprising a light blob, a touchpad to detect one or more gestures, and an electronic circuitry to generate electronic instructions corresponding to the gestures;
a detection system to determine a spatial position and/or movement of the at least one hand-held controller, the detection system comprising at least one image sensor to acquire one or more images of the at least one hand-held controller and a calculation device to determine the spatial position and/or movement based on the acquired images; and
a text input processor to perform operations comprising:
receiving the spatial position and/or movement of the at least one hand-held controller from the detection system;
generating an indicator in the virtual environment at a coordinate based on the received spatial position and/or movement of the at least one hand-held controller;
entering a text input mode when the indicator overlaps a text field in the virtual environment and upon receiving a trigger instruction from the at least one hand-held controller;
receiving the electronic instructions from the at least one hand-held controller; and
performing text input operations based on the received electronic instructions in the text input mode.

2. The electronic system of claim 1, wherein the text input processor is further configured to:
prior to entering the text input mode, enter a standby mode ready to perform the text input operations; and
upon receiving a trigger instruction, enter the text input mode from the standby mode, generate a cursor in the text field, and generate a text input interface in the virtual environment, wherein the text input interface comprises:
a first virtual interface having a plurality of virtual keys, each virtual key representing one or more characters;
a second virtual interface to display one or more candidate text strings; and
a third virtual interface to display one or more functional keys.

3. The electronic system of claim 2, wherein:
the touchpad of the at least one hand-held controller comprises a 3-by-3 grid of sensing areas;
the first virtual interface is a virtual keypad having one or more 3-by-3 grid layouts of the virtual keys, each virtual key of a current layout corresponding to a sensing area of the touchpad; and
the text input mode comprises at least two operational modes, including a character-selection mode and a string-selection mode, wherein:
in the character-selection mode, a clicking or tapping gesture detected in a sensing area of the touchpad causes a selection of one character in a corresponding virtual key of the current layout of the first virtual interface.

4. The electronic system of claim 3, wherein, in the character-selection mode, the text input operations comprise:
selecting one or more characters corresponding to one or more clicking gesture, sliding gesture, tapping gesture, and/or ray simulation detected by one or more sensing areas of the touchpad or one or more movements of the at least one hand-held controller; and
displaying one or more candidate text strings in the second virtual interface based on the selected one or more characters.

5. The electronic system of claim 4, wherein, in the character-selection mode, the text input operations further comprise:
deleting a character in the candidate text strings displayed in the second virtual interface upon receiving an electronic instruction corresponding to a backspace operation from the at least one hand-held controller.

6. The electronic system of claim 4, wherein, in the character-selection mode, the text input operations further comprise:
switching the current layout of the first virtual interface to a prior layout upon receiving an electronic instruction corresponding to a first sliding gesture detected by the touchpad; or
switching the current layout of the first virtual interface to a subsequent layout upon receiving an electronic instruction corresponding to a second sliding gesture detected by the touchpad;
wherein the direction of the first sliding gesture is opposite to that of the second sliding gesture.

7. The electronic system of claim 6, wherein the text input operations further comprise:
upon receiving an electronic instruction corresponding to a third sliding gesture detected by the touchpad, switching from the character-selection mode to the string-selection mode;
wherein the direction of the third sliding gesture is perpendicular to that of the first or second sliding gesture.

8. The electronic system of claim 3, wherein, in the string-selection mode, the text input operations comprise:
selecting one or more text strings based on one or more clicking gesture, sliding gesture, tapping gesture, and/or ray simulation detected by one or more sensing areas of the touchpad or one or more movements of the hand-held controller;
displaying the selected one or more text strings before the cursor in the text field;
deleting the selected one or more text strings from the candidate text strings in the second virtual interface;
updating the candidate text strings in the second virtual interface; and
closing the second virtual interface when no candidate text string is being displayed in the second virtual interface.

9. The electronic system of claim 2, wherein:
the touchpad of the at least one hand-held controller detects at least partially circular gestures;
the first virtual interface is a circular keypad having a pointer and the plurality of virtual keys distributed around its circumference, wherein the circular keypad is at least partially visible; and
the text input mode comprises at least two operational modes, including a character-selection mode and a string-selection mode, wherein:
in the character-selection mode, an at least partially circular gesture detected by the touchpad causes a rotation of the circular keypad and a selection of a virtual key by the pointer.

10. The electronic system of claim 9, wherein the electronic circuitry of the at least one hand-held controller determines the direction and distance of the rotation of the circular keypad based on the direction and distance of the detected at least partially circular gesture.

11. The electronic system of claim 9, wherein, in the character-selection mode, the text input operations comprise:
selecting one or more characters corresponding to one or more at least partially circular gestures detected by the touchpad; and
displaying or updating one or more candidate text strings in the second virtual interface based on the selected one or more characters.

12. The electronic system of claim 9, wherein the text input operations further comprise:
upon receiving an electronic instruction corresponding to a first sliding gesture detected by the touchpad, switching from the character-selection mode to the string-selection mode.

13. The electronic system of claim 9, wherein, in the string-selection mode, the text input operations comprise:
selecting one or more text strings based on one or more clicking, tapping, or at least partially circular gestures detected by the touchpad;
displaying the selected one or more text strings in the text field;
deleting the selected one or more text strings from the candidate text strings in the second virtual interface;
updating the candidate text strings in the second virtual interface; and
closing the second virtual interface when no candidate text string is being displayed in the second virtual interface.

14. A method for text input in a virtual environment, comprising:
receiving, using at least one processor, a spatial position of at least one hand-held controller, the at least one hand-held controller comprising a light blob, a touchpad to detect one or more gestures, and an electronic circuitry to generate one or more electronic instructions corresponding to the gestures;
generating, by the at least one processor, an indicator at a coordinate in the virtual environment based on the received spatial position and/or movement of the at least one hand-held controller;
entering, by the at least one processor, a text input mode when the indicator overlaps a text field in the virtual environment and upon receiving a trigger instruction from the at least one hand-held controller;
receiving, by the at least one processor, the electronic instructions from the at least one hand-held controller; and
performing, by the at least one processor, text input operations based on the received electronic instructions in the text input mode.

15. The method of claim 14, further comprising:
prior to entering the text input mode, entering, by the at least one processor, a standby mode ready to perform the text input operations; and
upon receiving the trigger instruction, entering the text input mode from the standby mode, by the at least one processor, generating a cursor in the text field, and generating a text input interface in the virtual environment, wherein the text input interface comprises:
a first virtual interface having a plurality of virtual keys, each virtual key representing one or more characters;
a second virtual interface to display one or more candidate text strings; and
a third virtual interface to display one or more functional and/or modifier keys.

16. The method of claim 15, wherein:
the touchpad of the at least one hand-held controller comprises a 3-by-3 grid of sensing areas;
the first virtual interface is a virtual keypad having one or more 3-by-3 grid layouts of the virtual keys, each virtual key of a current layout corresponding to a sensing area of the touchpad; and
the text input mode comprises at least two operational modes, including a character-selection mode and a string-selection mode, wherein:
in the character-selection mode, a clicking or tapping gesture detected in a sensing area of the touchpad causes a selection of one character in a corresponding virtual key of the current layout of the first virtual interface.

17. The method of claim 16, wherein, in the character-selection mode, the text input operations comprise:
selecting one or more characters corresponding to one or more clicking gesture, sliding gesture, tapping gesture, and/or ray simulation detected by one or more sensing areas of the touchpad or one or more movements of the at least one hand-held controller; and
displaying or updating one or more candidate text strings in the second virtual interface based on the selected one or more characters.

18. The method of claim 16, wherein, in the string-selection mode, the text input operations comprise:
selecting one or more text strings based on one or more clicking gesture, sliding gesture, tapping gesture, and/or ray simulation detected by one or more sensing areas of the touchpad or one or more movements of the hand-held controller;
displaying the selected one or more text strings before the cursor in the text field;
deleting the selected one or more text strings from the candidate text strings in the second virtual interface;
updating the candidate text strings in the second virtual interface; and
closing the second virtual interface when no candidate text string is being displayed in the second virtual interface.

19. The method of claim 15, wherein:
the touchpad of the at least one hand-held controller detects at least partially circular gestures;
the first virtual interface is a circular keypad having a pointer and the plurality of virtual keys distributed around its circumference, wherein the circular keypad is at least partially visible; and
the text input mode comprises at least two operational modes, including a character-selection mode and a string-selection mode; wherein
in the character-selection mode, an at least partially circular gesture detected by the touchpad causes a rotation of the circular keypad and a selection of a character by the pointer.

20. A method for text input in a virtual environment, comprising:
determining a spatial position of at least one hand-held controller;
generating an indicator at a coordinate in the virtual environment based on the spatial position and/or movement of the at least one hand-held controller;
entering a standby mode ready to perform text input operations;
entering a text input mode from the standby mode upon receiving a trigger instruction from the at least one hand-held controller;
receiving one or more electronic instructions from the at least one hand-held controller, the one or more electronic instructions corresponding to one or more gestures applied to the at least one hand-held controller; and
performing text input operations based on the received electronic instructions in the text input mode.
